(19) United States
(12) Patent Application Publication
(10) Pub. No.: US 2016/0159055 A1
(43) Pub. Date: Jun. 9, 2016

(54) LAMINATE COMPRISING FILM AND FIBER SHEET

(71) Applicant: TORAY INDUSTRIES, INC., Tokyo (JP)

(72) Inventors: Shohei YOSHIDA, Otsu-shi (JP); Yoko WAKAHARA, Otsu-shi (JP); Takuji HIGASHIOJI, Otsu-shi (JP)

(73) Assignee: TORAY INDUSTRIES, INC., Tokyo (JP)

(21) Appl. No.: 14/907,142

(22) PCT Filed: Jul. 10, 2014
(86) PCT No.: PCT/JP2014/068388

§ 371 Date: Jan. 22, 2016

(30) Foreign Application Priority Data
Jul. 25, 2013 (JP) 2013-154332
Feb. 24, 2014 (JP) 2014-032634

(51) Int. Cl. B32B 27/12; B32B 27/28

(52) U.S. Cl. CPC B32B 27/12; B32B 27/286; B32B 2262/0269; B32B 2307/206; B32B 2307/518; B32B 2457/04

(57) ABSTRACT

A laminate includes a biaxially oriented polyphenylene sulfide film layer (B layer); and a fiber sheet (A layer) composed of an aromatic polymer bonded on at least one side of the biaxially oriented polyphenylene sulfide film layer without an adhesive, wherein the laminate has an average tear strength of 1 to 6 N/mm in two perpendicular directions.

### TECHNICAL FIELD

This disclosure relates to a laminate comprising a biaxially oriented polyphenylene sulfide film and a fiber sheet composed of an aromatic polymer that are bonded with each other.

### BACKGROUND

In recent years, with enhancement of the functions and performance as well as increase in the capacity of electrical devices, an improvement in the reliability of insulation systems is desired. Accordingly, there is a demand for an insulating material that has a good balance of properties such as heat resistance, hydrolysis resistance, chemical resistance, electrical properties, mechanical properties and ease of handling. Further, with downsizing and weight reduction of electrical devices, there is also an increasing demand for a thinner insulating material. For instance, in motors used in HEVs (hybrid vehicles), EVs (electric vehicles) and the like that are referred to as “next-generation vehicles,” high reliability is demanded than ever before in reducing the thickness of an insulating material. Polyphenylene sulfide (hereinafter, may be referred to as “PPS”) films have a good balance of the above-described properties. Therefore, they have been widely used as a main component of an insulating material for motors. When a PPS film is used as an insulating material of a motor, for protection of the film surface, a fiber sheet is commonly laminated thereon. For example, a laminate in which an aromatic polyamide paper is laminated on the surface layer of a PPS film (Japanese Patent Application Laid-Open Publication (JP-A) No. 2011-140151) and laminates in which a PPS fiber sheet is laminated on the surface layer of a PPS film (JP-A Nos. S63-237949 and 2011-173418) have been proposed.

However, although such conventional laminates exhibit high hydrolysis resistance and high chemical resistance attributed to the properties of a PPS film since the interfacial adhesion between a fiber sheet and the PPS film is insufficient, surface friction and scratching during processing may cause delamination of the fiber sheet layer and damage may reach the inner layer of the film, preventing the fiber sheet from sufficiently functioning as a surface protective layer. For the purpose of improving the interfacial adhesion, methods of subjecting the bonding surface to a plasma treatment or coating the bonding surface with an adhesive made of a curable resin are known. However, satisfactory reliability may not be attained by either method because a plasma treatment does not provide a sufficient effect of improving the interfacial adhesion while coating with an adhesive impairs the long-term heat resistance and hydrolysis resistance. In addition, when the processing temperature in bonding of a PPS film and a fiber sheet by heat lamination is increased to improve the interfacial adhesion, not only continuous processing is difficult due to thermal contraction and wrinkling of the film and adhesion of the fiber sheet to the press rolls of a laminating machine, but also the fibers of the fiber sheet are severely deformed and collapsed after lamination so that the shape of the fiber sheet is not retained in some cases. Moreover, in conventional laminates since the insulation performance is markedly reduced when the laminates are made thinner, such thin laminates may not be suitable for the use in a high-voltage application where high reliability is demanded.

It could therefore be helpful to provide a laminate that exhibits excellent scratch resistance as well as high heat resistance and high electrical insulation (dielectric breakdown voltage) that are important in electrical insulation applications and has good insertability in processing.

### SUMMARY

We thus provide:

(1) A laminate comprising: a biaxially oriented polyphenylene sulfide film layer (B layer); and a fiber sheet (A layer) composed of an aromatic polymer bonded on at least one side of the biaxially oriented polyphenylene sulfide film layer without an adhesive, wherein the laminate has an average tear strength in a range of 1 to 6 N/mm in two perpendicular directions;

(2) The laminate according to (1), wherein the fiber sheet is composed of a polyphenylene sulfide resin;

(3) The laminate according to (1) or (2), wherein the biaxially oriented polyphenylene sulfide film layer (B layer) has a three-layer laminated constitution of X/Y/X or a two-layer laminated constitution of X/Y; the melting point of X layer, Tm(X), and that of Y layer, Tm(Y), have a relationship of Tm(X)<[Tm(Y)−10]; and the ratio of the thickness of the Y layer with respect to the total thickness of the film layer is in a range of 40% to 90%;

(4) The laminate according to any one of (1) to (3), wherein the average tear strength in the two perpendicular directions is in a range of 2 to 3.5 N/mm;

(5) The laminate according to any one of (1) to (4), having a total thickness in a range of 40 to 150 μm;

(6) The laminate according to any one of (1) to (5), wherein, in a cross-section there-of, the ratio of the B layer with respect to the whole laminate is in a range of 50 to 90%;

(7) The laminate according to any one of (1) to (6), having a dielectric breakdown voltage in a range of 60 to 350 kV/mm;

(8) The laminate according to any one of (1) to (7), which is used as an insulating paper for a motor; and

(9) The laminate according to any one of (1) to (8), the laminate not showing such a reduction in stress that satisfies both of the following conditions (i) and (ii) in a stress-strain curve obtained by tensile measurement in accordance with a method prescribed in JIS C2151:
(i) the stress is reduced by not less than 5 MPa while the elongation is increased by 2%; and
(ii) the behavior of (1) is observed at a stage where the elongation is less than the elongation at break.

A laminate having excellent scratch resistance can be obtained, and a laminate that exhibits high heat resistance and high electrical insulation (dielectric breakdown voltage), which are important in electrical insulation applications, and has good insertability in processing can be provided.

### BRIEF DESCRIPTION OF THE DRAWINGS

FIG. 1 shows a top view of a slit block.

### DESCRIPTION OF SYMBOLS

1: Slit gap

2: 4 mm

### DETAILED DESCRIPTION

Our fiber sheets and films will now be described.

The biaxially oriented polyphenylene sulfide film layer (B layer) is a layer consisting of only a film obtained by melt-molding a resin composition containing polyphenylene sulfide as a main component into the form of a sheet and then biaxially stretching and heat-treating the sheet.

The term “resin composition containing polyphenylene sulfide as a main component” (hereinafter, may also be referred to as “PPS resin composition”) means a composition containing polyphenylene sulfide in an amount of not less than 70% by mass, preferably not less than 90% by mass. When the PPS content is less than 70% by mass, the advantageous features of PPS fibers and PPS films such as heat resistance, dimensional stability and mechanical properties, may be impaired.

The term “PPS” refers to a polymer in which not less than 70% by mol (preferably not less than 85% by mol) of repeating units is composed of p-phenylene sulfide units represented by the structural formula (A). When the content of this component is less than 70% by mol, the crystallinity, thermal transition temperature and the like of the polymer are reduced so that the advantageous features of PPS such as heat resistance, dimensional stability and mechanical properties, may be impaired. The PPS may also comprise a unit containing a copolymerizable sulfide bond as long as the content thereof is less than 30% by mol, preferably less than 15% by mol of the repeating units.

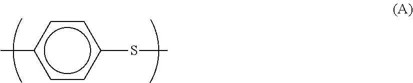

From the standpoint of performing stable spinning and film formation, the PPS has a weight-average molecular weight of preferably 7,500 to 500,000, more preferably 10,000 to 100,000.

The PPS resin composition may contain an additive(s) such as an inorganic filler, a resin other than PPS (different kind of polymer), a lubricant, a coloring agent and/or an ultra-violet absorber, as long as the amount thereof is less than 30% by mass. Examples of the inorganic filler include calcium carbonate, silica, titanium oxide, alumina, kaolin, calcium phosphate, barium sulfate, talc, zinc oxide and metals. These inorganic filler particles may be used individually, or two or more thereof may be used in combination. The shape of the particles is not particularly restricted and the particles may be, for example, in a spherical form, a cuboid form, a monodispersed form or an aggregated form. Examples of the different kind of polymer include organic particles that do not melt up to 300° C. such as polytetrafluoroethylene particles, silicone particles and cross-linked polystyrene particles; and polymers that can be processed at a high temperature of not lower than 300° C. such as polymethylpentene, cyclic cycloolefin, polyphenylene ether, polyethylene naphthalate, polyether imide and syndiotactic polystyrene.

From the standpoint of the moldability of the resulting fibers and film, the melt viscosity of the composition is preferably 100 to 2,000 Pa·s, more preferably 200 to 1,000 Pa·s, at a temperature of 310° C. and a shear rate of 1,000 (1/sec).

The “fiber sheet composed of an aromatic polymer” is a general term for a thin sheet-form article which is constituted by an fiber aggregate obtained by spinning a resin composition containing an aromatic polymer as a main component in accordance with a well-known method and usually referred to as “nonwoven fabric,” “paper,” “woven fabric,” “felt” or the like.

Examples of the aromatic polymer include aromatic polyamides, aromatic polyamide imides, aromatic polyimides, aromatic polyesters, aromatic polysulfides, aromatic polysulfones, aromatic polysulfoxides, aromatic polyether sulfones, aromatic polyethers, aromatic polyether ketones, aromatic polyether ether ketones and aromatic polycarbonates. Thereamong, aromatic polyamides and aromatic polysulfides are particularly preferred from the standpoints of interfacial adhesion with the above-described biaxially oriented polyphenylene sulfide film of B layer, long-term heat resistance, hydrolysis resistance, processability and electrical insulation.

To allow the PPS film to sufficiently exhibit the advantageous features of PPS films such as high electrical insulation, strength, processability, heat resistance and hydrolysis resistance, it is important that the PPS film be a biaxially oriented film, not an unstretched film or a uniaxially oriented film. As a stretching method, a sequential biaxial stretching method (a stretching method using a combination of one-directional stretching processes such as a method in which stretching is performed in the machine direction and then in the direction perpendicular to the machine direction), a simultaneous biaxial stretching method (a method in which stretching is performed simultaneously in the machine direction and the direction perpendicular thereto) or a combination of these methods can be employed. The draw ratio is preferably 2.5 to 4.1, more preferably 3.0 to 3.8, in both the machine direction and the direction perpendicular thereto. When the draw ratio is less than 2.5, the flatness of the film may be markedly impaired during post-stretching heat treatment. Meanwhile, when the draw ratio is higher than 4.1, the in-plane orientation of the film is excessively increased and the tear strength is thus reduced so that breakage or cracking may occur during processing such as punching or bending.

In the PPS film (B layer), it is preferred that two PPS resin compositions having different formulations (hereinafter, these resin compositions are each referred to as “X” and “Y”) be laminated in a three-layer constitution of X/Y/X or a two-layer constitution of X/Y. It is preferred that the melting point of the X layer, Tm(X) (° C.), and that of the Y layer, Tm(Y) (° C.), satisfy a relationship of Tm(X)<[Tm(Y)−10], more preferably Tm(X)<[Tm(Y)−15]. By adopting such a laminated constitution, when the film and the fiber sheet(s) are bonded by heat lamination without an adhesive (it should be noted here that the fiber sheet is bonded on both sides of the film when the film has the three-layer laminated constitution, or the fiber sheet is bonded only on the X layer side when the film has the two-layer laminated constitution), an improved interfacial adhesion between the film and the fiber sheet(s) can be attained. As a method of achieving the relationship of Tm(X)<[Tm(Y)−10], for example, a layer composed of a PPS resin composition containing a PPS in which a m-phenylene skeleton represented by the structural formula (B) is introduced into the molecular chain by copolymerization (hereinafter, such a PPS may also be referred to as “meta-copolymerized PPS”) can be used as the X layer and a layer composed of a PPS resin composition containing only a p-phenylene skeleton can be used as the Y layer. However, it is needless to say that this disclosure should not be interpreted in any restrictive way to this example. Considering general melting point characteristics of PPS resin compositions, the temperature range of Tm(Y) is practically 240 to 290° C., more preferably 250 to 285° C.

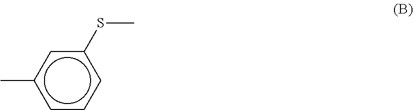

The melting points of the PPS resin compositions constituting the respective layers of the above-described biaxially oriented PPS film can be determined by observing a laminate cross-section exposed using a microtome under a scanning electron microscope to identify the position of an interface between the film layer and the fiber sheet layer; cutting out a trace amount of sample from an arbitrary part of the film with a focused ion beam; and then measuring the sample using a high-sensitive differential scanning calorimeter.

As for the lamination ratio of the X and Y layers in the biaxially oriented PPS film, with the thicknesses of the layers X on each side being defined as x and x′ and the thickness of the Y layer constituting the middle layer being defined as y, the ratio of the thickness of the Y layer with respect to the total thickness, (y/(x+x′+y)×100), is preferably 40% to 90%, more preferably 50% to 80%. If the ratio of the thickness of the Y layer is less than 40%, when the film is heat-bonded with the fiber sheet by heat lamination, thermal contraction of the film may cause generation of wrinkles. Meanwhile, if the ratio of the thickness of the Y layer is higher than 90% since the X layer is too thin, sufficient interfacial adhesion between the PPS film and the fiber sheet is not attained when the PPS film and the fiber sheet are bonded by heat lamination, which may lead to deterioration of scratch resistance. It is preferred that the thickness ratio of the X layers on each side, x/x′, be 0.5 to 2, because this reduces irregular processing on both sides of the film during heat lamination. The lamination ratio of the biaxially oriented PPS film can be adjusted as appropriate by changing the flow path volume in a laminating machine where the layers are merged together and/or the discharge rate of an extruder when forming the film by a known melt-extrusion method. When it is desired to increase the thickness of a particular layer, the flow path volume and/or the discharge rate corresponding to the layer can be increased.

The thickness of the biaxially oriented PPS film is preferably 20 to 120 μm, more preferably 25 to 90 μm. In this range, not only formation of the film can be carried out in a stable manner but also the thickness of the laminate obtained by bonding the film with the fiber sheet can be reduced so that a laminate suitable for downsizing and weight reduction of an electrical device can be obtained. The thickness of the biaxially oriented PPS film can be adjusted by changing the discharge rate of an extruder and/or the draw ratio in the formation of the film. The higher the discharge rate and the higher the draw ratio, the thinner becomes the resulting film.

The fiber sheet has an apparent specific gravity [a value (g/cm³) obtained by dividing the basis weight (g/m²) by the sheet thickness (μm)] of preferably 0.2 to 1.1 g/cm³, more preferably 0.3 to 0.9 g/cm³, prior to being bonded with the PPS film. By controlling the apparent specific gravity, an improved effect of protecting the film layer (scratch resistance) can be attained after the bonding of the fiber sheet with the PPS film.

When the aromatic polymer constituting the fiber sheet has crystallinity, it is preferred that, prior to the stage where the fiber sheet is bonded with the PPS film, the fiber sheet contain unstretched fibers as at least a part of its constituent fibers. The term “unstretched fibers” refers to fibers that are obtained by melt-spinning the polymer through a die using an extruder-type spinning machine or the like, with completely or almost no subsequent stretching that accompanies orientation of molecular chains. By incorporating unstretched fibers, the adhesion strength at the lamination interfaces in the heat-bonding between the PPS film and the fiber sheet can be increased, and the scratch resistance can thus be improved. For the purpose of reducing the diameter of the unstretched fibers, the unstretched fibers can also be draw-stretched in a hot medium such as heated ethylene glycol before being used.

The fiber sheet can be prepared by a common dry method or wet method. However, particularly, a wet-laid nonwoven fabric method by which a thin sheet is easily prepared with highly uniform thickness is preferred. A wet-laid nonwoven fabric method is a method in which, after spinning and cutting a resin composition into short fibers, a papermaking slurry is prepared by dispersing the short fibers in water, a paper is produced using a papermaking machine such as a cylinder-type, fourdrinier-type or inclined net-type papermaking machine or a manual papermaking machine, and the paper is then dried to obtain a fiber sheet. Upon papermaking, since short fibers having different resin formulations, short fibers in different stretched conditions and the like can be arbitrarily mixed together, by admixing the above-described unstretched short fibers to perform papermaking, the adhesion strength of the lamination interface can be further increased when the PPS film and the fiber sheet are heat-bonded.

In the fiber sheet, it is preferred that, prior to the stage where the fiber sheet is bonded with the PPS film, the constituent fibers have a fineness of not less than 0.05 dtex and not greater than 5 dtex. When the fibers are finer than 0.05 dtex, the fibers are easily entangled with each other and this makes it difficult to prepare a fiber sheet having a uniform thickness. Meanwhile, when the fineness is greater than 10 dtex since the fibers are thick and hard and this leads to weak entangling strength of the fibers, the resulting fiber sheet is prone to breakage. It is preferred that all of the fibers have a fineness of not less than 0.05 dtex and not greater than 10 dtex. However, as long as the desired effects are not impaired, the fibers may also include those fivers that have a fineness outside the above-described range.

The thickness of the fiber sheet is preferably 5 to 40 μm, more preferably 7 to 30 μm. When the thickness of the fiber sheet is less than 5 μm, the scratch resistance may be markedly reduced. Meanwhile, when the thickness of the fiber sheet is greater than 40 μm, the long-term heat resistance may be deteriorated.

In the laminate, it is important that the fiber sheet be bonded on at least one side of the biaxially oriented PPS film without an adhesive. The phrase “without an adhesive” means that, in the interface between the film and the fiber sheet, substantially only the PPS resin composition constituting the biaxially oriented PPS film and the aromatic polymer constituting the fiber sheet are present. Because of the absence of a low-heat-resistance layer of an adhesive or the like in the interface, even when the laminate is used for a prolonged period under a high-temperature and high-humidity environment, deterioration with time is limited and high mechanical properties can be retained. The presence of only the PPS resin composition in the interface of the laminate can be judged by analyzing a cross-section of the laminate along the thickness direction using an energy-dispersive X-ray spectrometer or a Fourier-transform infrared spectrophotometer and mapping the cross-section in the thickness direction.

A heat lamination method is preferably employed as a method of bonding the PPS film and the fiber sheet without an adhesive. The term “heat lamination” refers to a method of bonding the PPS film and the fiber sheet by heating them in a laminated state and then sandwiching and pressing the resultant between press rolls or the like. From the standpoint of the ease of processing, the step of bonding the PPS film and the fiber sheet by heat lamination is preferably performed after biaxial stretching the PPS film. However, alternatively, the fiber sheet may be heat-laminated on at least one side of the unstretched PPS film and then the film and the fiber sheet may be biaxially stretched at the same time.

For heat lamination of the fiber sheet on the PPS film that has been biaxially stretched, a common heat-laminating machine or calendaring machine can be used. However, in a conventional method, since it is difficult to provide sufficient interfacial adhesion solely by heat lamination, a laminate having high scratch resistance could not be obtained. The cause of this drawback is that, when the lamination temperature and pressure are increased in an attempt of improving the interfacial adhesion, the fibers of the fiber sheet are severely crushed into a film form so that the fiber sheet loses its original function as a protective layer and adheres to the press rolls during lamination, and the film is thermally expanded at a high temperature and this leads to generation of wrinkles upon subsequent cooling of the film. We discovered that an interfacial adhesion strength higher than ever before can be provided and a laminate having excellent scratch resistance can be obtained by allowing the PPS film to have a laminated constitution such that the resin of the surface layer(s) and that of the inner layer have a sufficient difference in melting point and by heat-laminating the PPS film in combination with a fiber sheet having appropriate thickness and fiber fineness at a lamination ratio that is set in a range suitable for heat lamination.

The processing temperature of the heat lamination is preferably 220° C. to 265° C., more preferably 225° C. to 260° C. When the processing temperature is lower than 220° C., the adhesion between the film and the fiber sheet is insufficient and the scratch resistance is reduced, while when the processing temperature is higher than 265° C., adhesion of the fiber sheet to the press rolls and generation of wrinkles may occur, and the fibers of the fiber sheet may be severely crushed to cause the fiber sheet to lose its function as a protective layer. From the standpoints of inhibiting adhesion of the fiber sheet to the press rolls as well as generation of wrinkles and preventing the fibers of the fiber sheet from being severely crushed, it is preferred to set the processing pressure (linear pressure) at higher than 50 kgf/cm but lower than 100 kgf/cm when the processing temperature is 220° C. to 250° C., or not lower than 10 kgf/cm but not higher than 50 kgf/cm when the processing temperature is higher than 250° C. but not higher than 265° C. The processing speed of the heat lamination is in a range of preferably 0.5 to 15 m/min, more preferably 1 to 12 m/min. When the processing speed is slower than 0.5 m/min, the lamination speed is not stably controlled so that irregular lamination may occur. Meanwhile, when the processing speed is faster than 15 m/min, heat transfer during pressing is insufficient, which may lead to insufficient adhesion between the film and the fiber sheet and a reduction in the scratch resistance.

Prior to heat lamination, the lamination surfaces of the PPS film and fiber sheet may also be subjected to a surface treatment such as corona treatment or plasma treatment.

When a cross-section of the outermost layer of the fiber sheet (layer on the opposite side of the interface adhered with the film) is observed under a scanning electron microscope at a magnification of ×500, preferably at least one, more preferably 5 or more fibers forming the outermost layer of the fiber sheet are observed to have a circular or elliptical cross-section with an independent interface. When such a fiber is not observed, the fibers of the fiber sheet are thermally fused into a film form so that the fiber sheet may lose its function as a protective film and the scratch resistance may be markedly deteriorated.

The thickness of the laminate is preferably 40 μm to 150 μm, more preferably 50 μm to 110 μm. By controlling the thickness of the laminate, in a motor insulation application where downsizing is required, space saving of an insulating material can be realized without impairing the ease of handling of the laminate as an insulating material, and an increase in the coil space factor can contribute to an increase in the motor output. At a thickness of less than 40 μm, since the laminate has low rigidity, the laminate may be easily buckled when inserted into a gap or the like of a motor. Meanwhile, when the thickness of the laminate is greater than 150 μm, not only the object of saving space by thinning of an insulating material cannot be achieved, but also excessively high rigidity may cause breakage and cracking during processing.

When the fiber sheet is laminated on both sides of the PPS film, the laminate has a constitution in which the fiber sheet and the PPS film are laminated in the order of: fiber sheet/biaxially oriented PPS film/fiber sheet. With the thicknesses of the fiber sheet layers (A layers) forming the outermost layers on the respective sides being defined as “a μm” and “a′ μm” and the thickness of the biaxially oriented PPS film layer (B layer) forming the middle layer as “b μm,” the ratio of the thickness of the biaxially oriented PPS film layer (B layer) with respect to the total thickness of the laminate, (b/(a+a′+b)×100), is preferably 50% to 90%, more preferably 55% to 90%. When the ratio of the thickness of the biaxially oriented PPS film layer (B layer) with respect to the total thickness of the laminate is less than 50%, the retention rate of the mechanical strength after a long-term retention under a high-temperature environment is reduced so that the reliability of the laminate as an insulating material may be impaired. Meanwhile, when the ratio of the thickness of the biaxially oriented PPS film layer (B layer) with respect to the total thickness of the laminate is higher than 90%, the laminate has excessively high rigidity so that breakage or cracking may occur during processing such as punching or bending, and since the fiber sheet layers are excessively thin, the effect of protecting the film layer may be lost. It is preferred that the thickness ratio of the A layers on each side, a/a′, be 0.5 to 2, because this reduces the unevenness of physical properties between the front and back of the laminate and also reduces the uneven processing between the front and back of the laminate during heat lamination. When the fiber sheet is laminated only on one side of the PPS film, with the thickness of the fiber sheet layer (A layer) being defined as “a μm” and the thickness of the biaxially oriented PPS film layer (B layer) as “b μm,” the ratio of the thickness of the biaxially oriented PPS film layer (B layer) with respect to the total thickness of the laminate is represented by (b/(a+b)×100) and, for the same reasons as described above, this ratio is preferably 50% to 90%, more preferably 55% to 90%.

It is important that the average tear strength in two perpendicular directions be not less than 1 N/mm and 6 N/mm or less, preferably not less than 1.5 N/mm and 4.5 N/mm or less, more preferably not less than 2 N/mm and 3.5 N/mm or less. By controlling the tear strength at 6 N/mm or less, the interfacial adhesion between the fiber sheet and the biaxially oriented PPS film is improved so that good scratch resistance is attained. Further, by controlling the tear strength to be not less than 1 N/mm, toughness can be provided so that breakage and cracking of the film that may occur during processing such as punching or bending can be inhibited. When the tear strength is less than 1 N/mm, the toughness is not sufficient as an insulator, and breakage or cracking of the film may occur during processing such as punching or bending. Meanwhile, when the tear strength is greater than 6 N/mm, since the adhesion in the lamination interface between the fiber sheet and the biaxially oriented PPS film is insufficient, interfacial delamination easily occurs due to surface friction and scratching during handling of the laminate. As for the mechanism by which interfacial delamination is made more likely to occur in a laminate having a tear strength of greater than 6 N/mm, we believe that, when the fiber sheet and the film are in a loose state without being sufficiently adhered, the fiber sheet and the film are each independently torn and this consequently increases the tear strength.

It is preferred that the laminate does not have such a reduction in stress that satisfies both of the following conditions (1) and (2) in a stress-strain curve obtained by tensile measurement in accordance with a method prescribed in JIS C2151:
(1) the stress is reduced by not less than 5 MPa while the elongation is increased by 2%; and
(2) the behavior of (1) is observed at a stage where the elongation is less than the elongation at break.

When a reduction in stress that satisfies both of the above-described conditions (1) and (2) is observed, since the adhesion in the lamination interface between the fiber sheet and the biaxially oriented PPS film is insufficient, interfacial delamination may easily occur due to surface friction and scratching during handling of the laminate.

The dielectric breakdown voltage is preferably not less than 60 kV/mm and 350 kV/mm or less, more preferably not less than 110 kV/mm and 350 kV/mm or less. When the dielectric breakdown voltage is less than 60 kV/mm, the laminate has low reliability as a thin-film insulating material and thus may not be able to withstand the use in an application where a high voltage is applied. Because of the properties of the biaxially oriented PPS film that serves as an electrical insulating layer, the upper limit of the dielectric breakdown voltage is about 350 kV/mm. To control the dielectric breakdown voltage at not less than 60 kV/mm, it is preferred to increase the thickness ratio of the B layer (biaxially oriented PPS film layer) in the laminate and to increase the thickness ratio of the Y layer in the biaxially oriented PPS film.

Preferably, an interfacial adhesion strength higher than ever before can be provided by allowing the PPS film to have a laminated constitution such that the resin of the surface layer(s) and that of the inner layer have a sufficient difference in melting point and by allowing the resin of the surface layer(s) of the film to impregnate between the fibers of the fiber sheet during heat lamination of the film and the fiber sheet. Accordingly, it is preferred that the thickness of the X layer(s) of the PPS film be less than that of the fiber sheet. When the fiber sheet has the same thickness as or is thicker than the X layer(s), the resin of the X layer(s) impregnated into the gaps of the fiber sheet may penetrate through the fiber sheet during heat lamination and bleeds out to the laminating roll side so that the continuous productivity may be markedly impaired.

A method of producing the laminate will now be described using a PPS fiber sheet as an example. However, this disclosure should not be interpreted in any restrictive way to this example.

### (1) Polymerization Method of Polyphenylene Sulfide

Sodium sulfide and dichlorobenzene are allowed to react in an amide-based polar solvent such as N-methyl-2-pyrrolidone (NMP) at a high temperature and a high pressure. If necessary, a copolymerizable component such as trihalobenzene can also be incorporated. Caustic potash, an alkali metal carboxylate or the like is added as a polymerization degree-adjusting agent to perform polymerization reaction at 230 to 280° C. Thereafter, the resulting polymer is cooled, made into an aqueous slurry and then filtered through a filter to obtain a granular polymer. An amide-based polar solvent is added thereto and the resulting mixture is stirred at 30 to 100° C. to wash the polymer. The polymer is further washed with ion-exchanged water at 30 to 80° C. several times and then with an aqueous metal salt solution such as calcium acetate several times. Subsequently, the thus washed polymer is dried to obtain PPS powder. The thus obtained powder particles are melt-kneaded and extruded into a strand shape using a uniaxial extruder having a preset temperature of 250 to 350° C., and the resulting strand was cut into pellets using a cutter. It is preferred that the dichlorobenzene used as a starting material contain not less than 70% by mol of p-dichlorobenzene and, for adjustment of the melting point of the resulting polyphenylene sulfide, a unit containing a copolymerizable sulfide bond such as m-dichlorobenzene may also be incorporated as long as the content thereof is less than 30% by mol, preferably less than 15% by mol.

### (2) Production of Biaxially Oriented Polyphenylene Sulfide Film

The PPS pellets obtained in the above-described manner are dried under reduced pressure and then fed to an extruder whose melting section has been heated to a temperature of 250 to 350° C., preferably 270 to 340° C. When a film having a three-layer laminated constitution is to be obtained, the pellets are introduced to a laminating machine provided above a mouthpiece such that the resin having a lower melting point is arranged as a surface layer. Subsequently, the resultant is discharged from a T-die mouthpiece and then tightly adhered and rapidly cooled to solidify on a cooling drum at 20 to 70° C. while applying thereto an electrostatic charge, thereby obtaining an unstretched three-layer laminated sheet. This three-layer laminated sheet has a three-layer constitution of X/Y/X. As for the lamination ratio of the X and Y layers, with the thicknesses of the X layers constituting the surfaces being defined as x and x′ and the thickness of the Y layer constituting the middle layer being defined as y, the ratio of the thickness of the Y layer with respect to the total thickness, (y/(x+x′+y)×100), is preferably 40% to 90%, more preferably 50% to 80%.

Next, the thus obtained unstretched film is biaxially oriented by biaxial stretching. As a stretching method, a sequential biaxial stretching method (a stretching method using a combination of one-directional stretching processes such as a method in which stretching is performed in the machine direction and then in the direction perpendicular to the machine direction), a simultaneous biaxial stretching method (a method in which stretching is performed simultaneously in the machine direction and the direction perpendicular thereto) or a combination of these methods can be employed. When a sequential biaxial stretching method in which stretching is performed first in the machine direction and then in the direction perpendicular thereto is employed will be described.

The unstretched polyphenylene sulfide film is heated with a group of heating rolls and subsequently stretched in the machine direction in a single step or in two or more steps at a draw ratio of 2.5 to 4.1, preferably 3.0 to 3.8. The stretching temperature is preferably 70 to 130° C., more preferably 80 to 110° C. The thus stretched film is then cooled with a group of cooling rolls at 20 to 50° C.

As a method of stretching the film in the direction perpendicular to the machine direction, for example, a method using a tenter is commonly employed. Both ends of the film stretched in the machine direction are held with clips and introduced to a tenter where the film is stretched in the direction perpendicular to the machine direction. The stretching temperature is preferably 70 to 130° C., more preferably 80 to 110° C. The draw ratio is 2.5 to 4.1, preferably 3.0 to 3.8.

Then, the thus biaxially stretched film is subjected to a heat treatment under extension. The heat treatment temperature is preferably 160 to 280° C., and the heat treatment is performed in a single step or in two or more steps. In this process, from the standpoint of thermal dimensional stability, it is preferred that the film be subjected to a 0 to 10% relaxation treatment in the width direction at the heat treatment temperature. When the heat treatment is performed in two steps, from the standpoints of improving the flatness of the film and attaining stable film formation, it is preferred that the first heat treatment be performed at 160 to 220° C. and the second heat treatment be performed at 230 to 280° C. which is higher than the temperature of the first heat treatment. After the heat treatment, the film is cooled to room temperature.

### (3) Production of PPS Fiber Sheet

The PPS pellets are dried under reduced pressure and then fed to a uniaxial melt-spinning extruder whose melting section has been heated to a temperature of 250 to 350° C., preferably 270 to 340° C. After extrusion, the resultant is subjected to fiber formation at a drawing speed of 200 to 5,000 m/min, and the resulting fibers are cut at a length of 1 to 50 mm to produce unstretched PPS short fibers. To reduce the diameter of the unstretched fibers, the unstretched fibers can also be subjected to 3 to 6-fold draw-stretching in ethylene glycol heated to 80 to 150° C. before being used. In the same manner, the unstretched fibers produced above are stretched at a temperature of 80 to 110° C. and a draw ratio of 2.5 to 4.5 before being cut and then cut at a length of 1 to 50 mm to produce stretched PPS short fibers. The thus obtained unstretched PPS short fibers and stretched PPS short fibers are mixed at a ratio of the unstretched PPS short fibers of 10 to 90%, preferably 20 to 80%, and the resulting mixture is subjected to papermaking using a papermaking machine which uses water as a dispersion medium and is equipped with a 30 to 500-mesh papermaking screen, thereby obtaining a PPS fiber sheet.

### (4) Bonding of PPS Film and PPS Fiber Sheet

Using a heat laminating machine comprising a heated metal roll and a silicone rubber roll, the biaxially oriented PPS film and the PPS fiber sheet are superimposed and heat-laminated such that the PPS fiber sheet is tightly adhered to the surface of the biaxially oriented PPS film. The processing temperature is preferably 220° C. to 265° C., more preferably 225° C. to 260° C. It is preferred to set the processing pressure (linear pressure) at higher than 50 kgf/cm but lower than 100 kgf/cm when the processing temperature is 220° C. to 250° C., or not lower than 10 kgf/cm but not higher than 50 kgf/cm when the processing temperature is higher than 250° C. but not higher than 265° C. The processing speed of the heat lamination is preferably 0.5 to 15 m/min, more preferably 1 to 12 m/min.

### EXAMPLES

The physical property values were measured and the effects were evaluated by the following methods.

### (1) Melting Point of Resin

In accordance with JIS K7121-1987, the melting point of a resin was measured using DSC (RDC220) manufactured by Seiko Instruments Inc. as a differential scanning calorimeter and Disc Station (SSC/5200) manufactured by Seiko Instruments Inc. as a data analyzer. On an aluminum tray, 3 mg of a sample was heated from room temperature to 340° C. at a heating rate of 20° C/min, and the temperature of the melting endothermic peak observed in this process was defined as the melting point (° C.).

### (2) Thickness of Laminate

Using a dial-gauge thickness meter with a flat tip (manufactured by Mitutoyo Corporation), the thickness was measured at 20 spots throughout the plane of the subject laminate and an average value thereof was determined.

### (3) Laminated Constitution of Laminate and Ratio of B Layer

A cross-section of the subject laminate exposed using a microtome was observed under a scanning electron microscope at a magnification of x500 and an enlarged image of the cross-section was photographed. The thickness of each layer was measured using an image analyzer. Ten test pieces were prepared and the thickness measurement was performed in the same manner for these test pieces. Based on the average value thereof, the laminated constitution of the laminate (μm) was determined. When the fiber sheet was laminated on both sides of the PPS film, the ratio of the PPS film layer (B layer) was calculated using an equation (b/(a+a′+b)×100), wherein the thicknesses of the fiber sheet layers (A layers) forming the outermost layers on the respective sides are defined as “a μm” and “a′ μm” and the thickness of the biaxially oriented PPS film layer (B layer) forming the middle layer is defined as “b μm.” When the fiber sheet was laminated only on one side of the PPS film, the ratio of the PPS film layer (B layer) was calculated using an equation (b/(a+b)×100), wherein the thickness of the fiber sheet layer (A layer) is defined as “a μm” and the thickness of the biaxially oriented PPS film layer (B layer) is defined as “b μm.”

### (4) Tear Strength

In accordance with JIS K7128 (and JIS P8116), the tear strength was measured using a light-load tearing tester (Type-D, manufactured by Toyo Seiki Seisaku-sho, Ltd.). In each of arbitrary perpendicular two directions of a sample, the tear strength was measured 20 times, and an average thereof was determined as the tear strength in the respective directions. A test piece was cut out in a rectangular shape of 63.5 mm in length and 50 mm in width and, as a tear initiation point, a 12.7 mm-long notch parallel to the long side was made at an end in the center of the short side.

### (5) Dielectric Breakdown Voltage

In accordance with JIS C2151, the dielectric breakdown voltage was measured using an alternating-current dielectric breakdown tester (manufactured by Kasuga Electric Works Ltd., AC 30 kV). For a square test piece of 25 cm×25 cm in size that had been humidified in an environment of 23° C. and 65% RH, the measurement was performed at a frequency of 60 Hz and a voltage increase rate of 1,000 V/sec. As for the shapes of the electrodes that were used, the lower electrode serving as a base had a cylindrical shape of 75 mm in diameter φ and 15 mm in height and the upper electrode had a cylindrical shape of 25 mm in diameter φ and 25 mm in height. In both of these electrodes, the surface of the test piece-holding side was smoothened at R of 3 mm.

### (6) Fiber Shape Retention

A cross-section of the subject laminate exposed using a microtome was observed under a scanning electron microscope at a magnification of ×500 and it was visually verified whether or not the cross-sections of the fibers forming the outermost layer of the fiber sheet (layer on the opposite side of the interface adhered with the film) had a circular or elliptical shape with an independent interface. The same operations were performed for the cross-sections of 10 test pieces, and the fiber shape retention was evaluated based on the following criteria. Fiber Shape Retention
A: The cross-sections of five or more fibers were observed to have a circular or elliptical shape.
B: The cross-sections of one to less than five fibers were observed to have a circular or elliptical shape.
C: Absolutely no fiber was observed to have a circular or elliptical cross-sectional shape.

### (7) Flatness

A sample of 5 m×1 m in size was prepared and placed on a flat board larger than the sample with the four corners being immobilized thereon (placed with application of tension in all directions such that the whole sample was not bent or loose). The board was then transferred to a dark room where the sample was irradiated with light of a fluorescent lamp from a lateral direction of the board at a certain intensity and angle of irradiation. Bulges and recesses in the sample plane generated shadows in the surrounding; therefore, while changing the direction of irradiation, general shapes of the bulges and recesses were visually estimated and their shapes were marked with a pen by tracing the edges. From the sum of the marked areas, the proportion of the bulges and recesses in the sample plane was calculated, and the flatness was evaluated based on the following criteria.

### Flatness

A: No shadow was observed.

B: Bulges and recesses were observed in some parts (not less than 10% to less than 90% of the total area).

C: Bulges and recesses were observed over the entire plane (not less than 90% of the total area).

### (8) Scratch Resistance

Referring to the pencil hardness test prescribed in JIS K5600-5-4, the surface of a test piece was subjected to a scratch test using a 0.9 mm-φ stainless steel wire having a tip processed into a hemispherical shape in place of a pencil. Using a surface property measuring apparatus (HEIDON-14D, manufactured by Shinto Scientific Co., Ltd.), the wire was clamped and immobilized with a pinvice and then set on a special pencil holder. The test piece was immobilized on a smooth glass plate, set at a prescribed position and then adjusted such that the spherical tip of the wire came into contact with the laminate surface at an angle of 45°. Scratching treatment was performed by reciprocally moving the wire five times over a moving distance of 10 mm at a moving speed of 300 mm/min. To determine whether or not the thus generated scratches penetrated through the fiber sheet and reached the film layer, a cross-section was exposed in the direction perpendicular to the scratches and then observed under a scanning electron microscope. The same scratching treatment was performed while changing the load applied to the wire tip in a range of 0 g to 500 g to determine the minimum load required for a scratch to reach the film layer and, based this minimum load, the scratch resistance was evaluated by the below-described criteria. The measurement was performed 10 times for each surface of the subject laminate on which the fiber sheet was laminated, and the value obtained for the surface with a smaller minimum load was used for the evaluation.

### Scratch Resistance

AA: The minimum load was 220 g or greater.

A: The minimum load was 200 g or greater but less than 220 g.

B: The minimum load was 150 g or greater but less than 200 g.

C: The minimum load was less than 150 g.

### (9) Ease of Handling

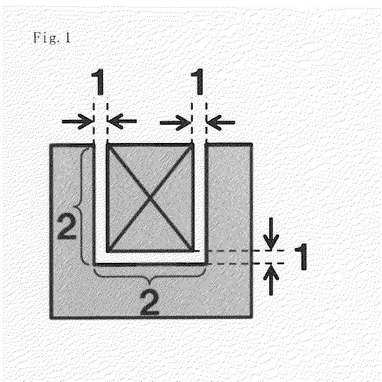

A ∪-shaped slit block with adjustable slit gaps (4 mm in length along each side of the ∪ shape and 50 mm in slit depth; FIG. 1) was prepared and adjusted such that all of the slit gaps uniformly had a space 1.2 times thicker than the thickness of the subject laminate. Then, the laminate which was bent-molded into a ∪ shape was inserted by about 20 mm and, based on the state thereof, the ease of handling was assessed as described below. The material of the slit block was silicon steel and the slit block had a surface roughness (SRa) of 2 μm. The bending into a u shape was performed using a motor processing machine (manufactured by Odawara Engineering Co., Ltd.). Specifically, the laminate was punched into a 12 mm×80 mm rectangle and then bent in three at 4 mm intervals along the short side. These processes of punching and bending were continuously performed to prepare 100 test pieces and their ease of handling was evaluated by the following criteria.

### Ease of Handling

AA: The insertability presented no problem and the laminate could be relatively easily inserted.

A: The laminate could be inserted; however, the laminate got stuck slightly during insertion, or had insufficient stiffness and was thus buckled.

B: During processing, the laminate showed breakage and/or cracking in some cases.

C: The laminate got stuck during insertion or had insufficient stiffness and was thus easily buckled; therefore, insertion was difficult.

### (10) Long-term Heat Resistance

A test piece of 10 mm in width and 250 mm in length was placed in a hot air oven having a preset temperature of 210° C. and heat-treated for 2,000 hours. The breaking strength was measured before and after the heat treatment and the strength retention rate was calculated using the equation below. The results thereof were evaluated based on the below-described criteria. The breaking strength was measured using a Tensilon tensile tester in accordance with the method prescribed in JIS C2151. A sample piece of 10 mm in width was set at a chuck distance of 100 mm and subjected to a tensile test at a tensile rate of 300 mm/min. The measurement was performed 10 times under this condition, and the average thereof was determined.

Strength retention rate (%)=Y/Y0×100

Y0: breaking strength before heat treatment (MPa)

Y: breaking strength after heat treatment (MPa)

### Long-term Heat Resistance

A: The strength retention rate was 85% or higher.

B: The strength retention rate was 80% or higher but lower than 85%.

C: The strength retention rate was lower than 80%.

### (11) Interfacial Adhesion (Rubbing Test)

Using a Scott-type folding and abrasion tester (manufactured by Toyo Seiki Seisaku-sho, Ltd.), a rubbing test was conducted in accordance with JIS K6328. The sample had a size of 10 mm in width and 200 mm in length and was measured under a load of 2.5 kg to determine the number of rubs that were performed before tearing or breakage was visually confirmed in the interface between the film and the fiber sheet. The interfacial adhesion was evaluated based on the following criteria.

### Interfacial Adhesion (Rubbing Test)

AA: 100 times or more

A: not less than 60 times but less than 100 times

B: not less than 30 times but less than 60 times

C: less than 30 times

### (12) Interfacial Adhesion (Tensile Test)

In accordance with the method prescribed in JIS C2151, the interfacial adhesion was measured using an Instron-type tensile tester under the following conditions.

Measuring apparatus: automatic film strength and elongation measuring apparatus “TENSILON AMF/RTA-100,” manufactured by Orientec Co., Ltd.

Sample size: 10 mm in width×100 mm in gauge length

Tensile rate: 300 mm/min

Measuring environment: temperature=23° C., humidity=65% RH

By analyzing a stress-strain curve (S-S curve) obtained by the measurement, the presence or absence of a section showing a stepwise reduction in stress (such a change that the stress is reduced by not less than 5 MPa while the elongation is increased by 2%) prior to reaching the final breaking point (a point at which the elongation is less than the elongation at break) was examined, and the interfacial adhesion was evaluated based on the following criteria.

### Interfacial Adhesion (Tensile Test)

A: No stepwise reduction in stress was observed.

C: A stepwise reduction in stress was observed.

### Reference Example 1

### Preparation of PPS Resin (PPS-1)

To an autoclave, 9.44 kg (80 mol) of 47% sodium hydrosulfide, 3.43 kg (82.4 mol) of 96% sodium hydroxide, 13.0 kg (131 mol) of N-methyl-2-pyrrolidone (NMP), 2.86 kg (34.9 mol) of sodium acetate and 12 kg of ion-exchanged water were loaded. The loaded materials were slowly heated to 235° C. over a period of 3 hours at atmospheric pressure under nitrogen flow to distill off 17.0 kg of water and 0.3 kg (3.23 mol) of NMP, and the reaction vessel was cooled to 160° C. Subsequently, 11.5 kg (78.4 mol) of p-dichlorobenzene (p-DCB) as a main monomer and 0.007 kg (0.04 mol) of 1,2,4-trichlorobenzene as an auxiliary monomer were added, and 22.2 kg (223 mol) of NMP was further added. The reaction vessel was hermetically sealed under nitrogen gas, and the resulting mixture was heated with stirring at 400 rpm from 200° C. to 270° C. at a rate of 0.6° C./min. After retaining the mixture at 270° C. for 30 minutes, 1.11 kg (61.6 mol) of water was injected into the system over a period of 10 minutes, and the mixture was further allowed to react at 270° C. for 100 minutes. Thereafter, 1.60 kg (88.8 mol) of water was again injected into the system and the system was cooled to 240° C. The system was further cooled to 210° C. at a rate of 0.4° C./min, followed by rapid cooling to about room temperature. After removal of the content and dilution thereof with 32 L of NMP, the solids were separated from the solvent by filtration through a sieve (80-mesh). The thus obtained particles were washed again with 38 L of NMP at 85° C. Thereafter, the particles were washed five times with 67 L of heated water and recovered by filtration, followed by washing with 70,000 g of 0.05%-by-mass aqueous calcium acetate solution five times and subsequent recovery by filtration. The resulting particles were dried in hot air at 60° C. and then at 120° C. under reduced pressure for 20 hours, thereby obtaining white powder particles of polyphenylene sulfide resin. The thus obtained powder particles were melt-kneaded and extruded into a strand shape using a uniaxial extruder whose temperature was set at 320° C., and the resulting strand was cut into pellets using a cutter. The thus obtained pellets of PPS resin had a melting point of 280° C.

### Reference Example 2

### Preparation of Meta-copolymerized PPS (PPS-2)

Powder particles of meta-copolymerized PPS resin were prepared in the same manner as in Reference Example 1, except that 70.6 mol of p-dichlorobenzene was used as a main monomer and 7.8 mol of m-dichlorobenzene and 0.04 mol of 1,2,4-trichlorobenzene were used as auxiliary monomers. The thus obtained powder particles were melt-kneaded and extruded into a strand shape using a uniaxial extruder whose temperature was set at 300° C., and the resulting strand was cut into pellets using a cutter. The thus obtained pellets of meta-copolymerized PPS resin had a melting point of 255° C.

### Reference Example 3

### Preparation of Meta-copolymerized PPS (PPS-3)

Powder particles of meta-copolymerized PPS resin were prepared in the same manner as in Reference Example 1, except that 66.6 mol of p-dichlorobenzene was used as a main monomer and 11.8 mol of m-dichlorobenzene and 0.04 mol of 1,2,4-trichlorobenzene were used as auxiliary monomers. The thus obtained powder particles were melt-kneaded and extruded into a strand shape using a uniaxial extruder whose temperature was set at 300° C., and the resulting strand was cut into pellets using a cutter. The thus obtained pellets of meta-copolymerized PPS resin had a melting point of 235° C.

### Example 1

### (a) Preparation of Biaxially Oriented PPS Film

The pellets of PPS-1 and PPS-2 prepared in Reference Examples 1 and 2, respectively, were each vacuum-dried at 180° C. for 3 hours and fed to two separate extruders. The pellets in a molten state were introduced to a laminating machine provided above a mouthpiece such that PPS-1 and PPS-2 were laminated in three layers (lamination order=PPS-2/PPS-1/PPS-2, lamination ratio=1:4:1). Subsequently, the resultant was discharged from a T-die mouthpiece and then tightly adhered and rapidly cooled to solidify on a casting drum having a surface temperature of 25° C. while applying thereto an electrostatic charge, thereby obtaining an unstretched three-layer laminated sheet. Then, the thus obtained laminated sheet was passed through plural heating rolls having a surface temperature of 95° C. in contact and 3.6-fold stretched in the machine direction between the heating rolls and 30° C. cooling rolls which were arranged downstream of the heating rolls and had a different peripheral speed. Using a tenter, the thus obtained uniaxially stretched sheet was 3.7-fold stretched at 100° C. in the direction perpendicular to the machine direction and then subjected to a first heat treatment at 200° C. and a second heat treatment at 265° C. Further, the resulting sheet was subjected to a 5% relaxation treatment in the transverse direction in a 260° C. relaxation treatment zone and subsequently cooled to room temperature, followed by removal of film edges, thereby obtaining a 50 pm-thick biaxially oriented three-layer laminated film of meta-copolymerized PPS/PPS/meta-copolymerized PPS.

### (b) Preparation of PPS Fiber Sheet

The pellets of PPS-1 prepared in Reference Example 1 were vacuum-dried at 165° C. for 5 hours. Then, the dried pellets were subjected to fiber formation using a uniaxial melt-spinning apparatus at an extrusion temperature of 320° C. and a drawing speed of 1,000 m/min, and the resulting fibers were cut at a length of 6 mm to produce unstretched PPS short fibers having a fineness of 3.0 dtex. In the same manner, fibers were prepared using a uniaxial melt-spinning apparatus at an extrusion temperature of 320° C. and a drawing speed of 1,000 m/min, and the resulting fibers were stretched at a temperature of 95° C. and a draw ratio of 3.2 and then cut at a length of 6 mm to produce stretched PPS short fibers having a fineness of 1.0 dtex. The thus obtained unstretched PPS short fibers and stretched PPS short fibers were mixed at a ratio of the unstretched PPS short fibers of 40%, and the resulting mixture was subjected to papermaking using a manual papermaking machine (manufactured by Kumagai Riki Kogyo Co., Ltd.) in which water was used as a dispersion medium and a 150-mesh papermaking screen was arranged on the bottom, thereby obtaining a 25 μm-thick PPS fiber sheet having a basis weight of 17 g/m².

### (c) Bonding of PPS Film and PPS Fiber Sheet

Using a heat laminating machine comprising a metal roll and a silicone rubber roll, the PPS film and the PPS fiber sheets were pasted together by superimposing and heat-laminating them such that the PPS fiber sheets were tightly adhered to each side of the PPS film, thereby obtaining a 90 μm-thick laminate. As for the lamination conditions, the lamination was performed at a temperature of 245° C., a pressure of 70 kgf/cm and a rate of 2 m/min.

### Example 2

A 90 μm-thick laminate was obtained in the same manner as in Example 1, except that the lamination temperature was changed to 260° C.

### Example 3

A 90 μm-thick laminate was obtained in the same manner as in Example 1, except that the lamination pressure was changed to 30 kgf/cm.

### Example 4

### (a) Preparation of Biaxially Oriented PPS Film

A 40 μm-thick biaxially oriented three-layer laminated film of meta-copolymerized PPS/PPS/meta-copolymerized PPS was obtained in the same manner as in Example 1, except that the discharge rate of the extruder was adjusted such that the resulting film had a final thickness of 40 μm.

### (b) Preparation of PPS Fiber Sheet

The pellets of PPS-1 prepared in Reference Example 1 were vacuum-dried at 165° C. for 5 hours. Then, the dried pellets were subjected to fiber formation using a melt-spinning apparatus at an extrusion temperature of 320° C. and a drawing speed of 1,000 m/min, and the resulting fibers were draw-stretched in 115° C. ethylene glycol at a draw ratio of 4 and then cut at a length of 6 mm to produce unstretched PPS short fibers having a fineness of 1.5 dtex. In the same manner, fibers were prepared using a melt-spinning apparatus at an extrusion temperature of 320° C. and a drawing speed of 1,000 m/min. The resulting fibers were draw-stretched in 115° C. ethylene glycol at a draw ratio of 4, further stretched at a temperature of 95° C. and a draw ratio of 3.2 and then cut at a length of 6 mm to produce stretched PPS short fibers having a fineness of 0.6 dtex. The thus obtained unstretched PPS short fibers and stretched PPS short fibers were mixed at a ratio of the unstretched PPS short fibers of 40%, and the resulting mixture was subjected to papermaking using a papermaking machine in which water was used as a dispersion medium, thereby obtaining a 13 μm-thick PPS fiber sheet having a basis weight of 10 g/m².

### (c) Bonding of PPS Film and PPS Fiber Sheet

A 60 μm-thick laminate was obtained in the same manner as in Example 1, except that the PPS film and PPS fiber sheet prepared in (a) and (b) of this Example, respectively, were used.

### Example 5

### (a) Preparation of Biaxially Oriented PPS Film

A 50 μm-thick three-layer laminated film was obtained in the same manner as in Example 1, except that the materials were fed to two extruders such that, in the resulting three-layer laminate, the middle layer was constituted by PPS-1 alone and the surface layers were both constituted by a mixture of 30% by mass of PPS-1 and 70% by mass of PPS-2. In the thus obtained film, the middle layer had a melting point of 280° C. and the surface layers both had a melting point of 266° C.

### (b) Preparation of PPS Fiber Sheet

A 25 μm-thick PPS fiber sheet was prepared in the same manner as in Example 1.

### (c) Bonding of PPS Film and PPS Fiber Sheet

A 90 μm-thick laminate was obtained in the same manner as in Example 1, except that the PPS film and PPS fiber sheet prepared in (a) and (b) of this Example, respectively, were used.

### Example 6

A 140 μm-thick laminate was obtained in the same manner as in Example 1, except that the discharge rate was adjusted in the preparation of a biaxially oriented PPS film such that the resulting film had a final thickness of 100 μm.

### Example 7

### (a) Preparation of Biaxially Oriented PPS Film

A 45 μm-thick three-layer laminated film was obtained in the same manner as in Example 1, except that PPS-3 prepared in Reference Example 3 was used as a starting material in place of PPS-2 and that the discharge rate was adjusted such that the resulting film had a final thickness of 45 μm. In the thus obtained film, the middle layer had a melting point of 280° C. and the surface layers both had a melting point of 235° C.

### (b) Preparation of PPS Fiber Sheet

A 25 μm-thick PPS fiber sheet was prepared in the same manner as in Example 1.

### (c) Bonding of PPS Film and PPS Fiber Sheet

A 85 μm-thick laminate was obtained in the same manner as in Example 1, except that the PPS film and PPS fiber sheet prepared in (a) and (b) of this Example, respectively, were used and that the lamination temperature was changed to 235° C.

### Example 8

A 90 μm-thick laminate was obtained in the same manner as in Example 1, except that the lamination ratio of PPS-1 and PPS-2 was adjusted to 1:25:1 in the preparation of a biaxially oriented PPS film.

### Example 9

A 90 μm-thick laminate was obtained in the same manner as in Example 1, except that the lamination ratio of PPS-1 and PPS-2 was adjusted to 1:1:1 in the preparation of a biaxially oriented PPS film.

### Example 10

A 90 μm-thick laminate was obtained in the same manner as in Example 1, except that the lamination conditions were changed to a temperature of 270° C. and a pressure of 30 kgf/cm.

### Example 11

A 90 μm-thick laminate was obtained in the same manner as in Example 1, except that, in the preparation of a biaxially oriented PPS film, the draw ratio in the machine direction was changed to 3.9 and the draw ratio in the direction perpendicular to the machine direction was changed to 4.0.

### Example 12

### (a) Preparation of Biaxially Oriented PPS Film

A 135 μm-thick biaxially oriented three-layer laminated film of meta-copolymerized PPS/PPS/meta-copolymerized PPS was obtained in the same manner as in Example 1, except that the discharge rate of the extruder was adjusted such that the resulting film had a final thickness of 135 μm and that the lamination ratio of PPS-1 and PPS-2 was adjusted to 1:25:1.

### (b) Preparation of PPS Fiber Sheet

The pellets of PPS-1 prepared in Reference Example 1 were vacuum-dried at 165° C. for 5 hours. Then, the dried pellets were subjected to fiber formation using a melt-spinning apparatus at an extrusion temperature of 320° C. and a drawing speed of 1,000 m/min, and the re=sulting fibers were draw-stretched in 115° C. ethylene glycol at a draw ratio of 6 and then cut at a length of 6 mm to produce unstretched PPS short fibers having a fineness of 0.7 dtex. In the same manner, fibers were prepared using a melt-spinning apparatus at an extrusion temperature of 320° C. and a drawing speed of 1,000 m/min. The resulting fibers were draw-stretched in 115° C. ethylene glycol at a draw ratio of 6, further stretched at a temperature of 95° C. and a draw ratio of 3.3 and then cut at a length of 6 mm to produce stretched PPS short fibers having a fineness of 0.4 dtex. The thus obtained unstretched PPS short fibers and stretched PPS short fibers were mixed at a ratio of the unstretched PPS short fibers of 40%, and the resulting mixture was subjected to papermaking using a papermaking machine in which water was used as a dispersion medium, thereby obtaining a 7 μm-thick PPS fiber sheet having a basis weight of 6 g/m².

### (c) Bonding of PPS Film and PPS Fiber Sheet

A 147 μm-thick laminate was obtained in the same manner as in Example 1, except that the PPS film and PPS fiber sheet prepared in (a) and (b) of this Example, respectively, were used.

### Example 13

A 150 μm-thick laminate was obtained in the same manner as in Example 1, except that a 50 μm-thick sheet of “NOMEX” (registered trademark) Type 410 manufactured by DuPont Teijin Advanced Papers Ltd. was prepared as a representative example of an aromatic polyamide fiber sheet and used as a fiber sheet.

### Example 14

A 150 μm-thick laminate was obtained in the same manner as in Example 1, except that a 50 μm-thick PPS fiber sheet, which was obtained by changing the papermaking basis weight to 40 g/m² in the preparation of a PPS fiber sheet in Example 1, was used as a fiber sheet.

### Comparative Example 1

A 90 μm-thick laminate was obtained in the same manner as in Example 1 except that, in the preparation of a biaxially oriented PPS film, a single-layer biaxially oriented PPS film was prepared using only PPS-1 as a starting material.

### Comparative Example 2

A 40 μm-thick laminate was obtained in the same manner as in Comparative Example 1, except that the lamination conditions were changed to a temperature of 270° C. and a pressure of 70 kgf/cm.

### Comparative Example 3

A 90 μm-thick laminate was obtained in the same manner as in Comparative Example 1, except that the bonding surfaces of the PPS film and the PPS fiber sheets were subjected to a plasma treatment (treatment intensity: 650 w·min/m²) prior to the heat-lamination process.

### Comparative Example 4

A 30 μm-thick laminate was obtained in the same manner as in Example 4, except that, in the preparation of a biaxially oriented PPS film, only PPS-1 was used as a starting material and the discharge rate was adjusted such that the resulting film had a final thickness of 10 μm; and that the lamination conditions for bonding the PPS film and the PPS fiber sheets were changed to a temperature of 245° C. and a pressure of 70 kgf/cm.

### Comparative Example 5

A 160 μm-thick laminate was obtained in the same manner as in Example 6, except that the materials were fed to two extruders such that, in the resulting biaxially-oriented three-layer laminated PPS film, the middle layer was constituted by PPS-1 alone and the surface layers were both constituted by a mixture of 80% by mass of PPS-1 and 20% by mass of PPS-2; and that the discharge rate was adjusted such that the resulting film had a final thickness of 120 μm. In the thus obtained laminated film, the middle layer had a melting point of 280° C. and the surface layers both had a melting point of 275° C.

### Comparative Example 6

### (a) Preparation of Unstretched PPS Film and Biaxially Stretched PPS Film

The pellets of PPS-1 prepared in Reference Example 1 were vacuum-dried at 180° C. for 3 hours. Then, the dried pellets were fed to an extruder, discharged from a T-die mouthpiece and then tightly adhered and rapidly cooled to solidify on a casting drum having a surface temperature of 25° C. while applying thereto an electrostatic charge, thereby obtaining a 25 thick unstretched single-layer PPS film.

Further, a 450 unstretched single-layer PPS film was obtained in the same manner as described above. Then, using a longitudinal stretching machine comprising a group of rolls, this film was stretched in the machine direction at a temperature of 98° C. and a draw ratio of 3.6. The film was subsequently fed to a tenter and stretched in the width direction at a temperature of 98° C. and a draw ratio of 3.5. The film was further subjected to a 10-second heat treatment at 265° C. to obtain a 50 μm-thick biaxially oriented PPS film. Both sides of this biaxially oriented PPS film were subjected to a corona discharge treatment at 6,000 J/m².

### (b) Preparation of PPS Fiber Sheet

The pellets of PPS-1 prepared in Reference Example 1 were vacuum-dried at 165° C. for 5 hours. Subsequently, the dried pellets were subjected to fiber formation using a uniaxial melt-spinning apparatus at an extrusion temperature of 320° C. and a drawing speed of 1,000 m/min, and the resulting fibers were cut at a length of 6 mm to produce short fibers. Then, the thus obtained short fibers were laminated and the resultant was needle-punched at a needle depth of 5 mm and a needle density of 150/cm². Thereafter, the resultant was calendered at 240° C. to obtain a 50 μm-thick PPS fiber sheet.

### (c) Bonding of PPS Film and PPS Fiber Sheet

Using a heat laminating machine, the thus obtained unstretched single-layer PPS film, biaxially oriented PPS film and PPS fiber sheet were superimposed and heat-laminated in five layers in the order of: PPS fiber sheet/unstretched single-layer PPS film/biaxially oriented PPS film/unstretched single-layer PPS film/PPS fiber sheet, thereby obtaining a 190 μm-thick laminate. As for the lamination conditions, the lamination was performed at a temperature of 245° C., a pressure of 10 kgf/cm and a rate of 1 m/min. Regarding the laminated constitution of the laminate, the B layer was defined as a combination of the unstretched single-layer PPS film layers and the biaxially oriented PPS film layer and the ratio thereof was calculated.

### Comparative Example 7

A 150 μm-thick laminate was obtained in the same manner as in Comparative Example 3, except that a 50 μm-thick sheet of “NOMEX” (registered trademark) Type 410 manufactured by DuPont Teijin Advanced Papers Ltd. was prepared as a representative example of an aromatic polyamide fiber sheet and used as a fiber sheet.

TABLE 1

| | Thickness | Laminated constitution: | | | | | Dielectric |
|---|---|---|---|---|---|---|---|
| | of laminate | A layer/B layer/A layer | Ratio of B | Tear strength (N/mm) | | | breakdown |
| | (μm) | (μm) | layer (%) | MD | TD | Average | voltage (kV/mm) |
| Example 1 | 90 | 20/50/20 | 56 | 2.5 | 4.2 | 3.4 | 130 |
| Example 2 | 90 | 20/50/20 | 56 | 2.2 | 2.7 | 2.5 | 130 |
| Example 3 | 90 | 20/50/20 | 56 | 4.2 | 4.6 | 4.4 | 120 |
| Example 4 | 60 | 10/40/10 | 67 | 2.1 | 2.6 | 2.4 | 150 |
| Example 5 | 90 | 20/50/20 | 56 | 5.3 | 6.1 | 5.7 | 120 |
| Example 6 | 140 | 20/100/20 | 71 | 2.5 | 4.2 | 3.4 | 240 |
| Example 7 | 85 | 20/45/20 | 53 | 1.9 | 3.6 | 2.8 | 100 |
| Example 8 | 90 | 20/50/20 | 56 | 5.4 | 5.8 | 5.6 | 115 |
| Example 9 | 90 | 20/50/20 | 56 | 2.5 | 4.2 | 3.4 | 130 |
| Example 10 | 90 | 20/50/20 | 56 | 2.4 | 4.0 | 3.2 | 130 |
| Example 11 | 90 | 20/50/20 | 56 | 1.6 | 2.1 | 1.9 | 130 |
| Example 12 | 147 | 6/135/6 | 92 | 1.2 | 1.6 | 1.4 | 200 |
| Example 13 | 150 | 50/50/50 | 33 | 5.5 | 5.8 | 5.7 | 90 |
| Example 14 | 150 | 50/50/50 | 33 | 3.2 | 3.5 | 3.4 | 90 |
| Comparative | 90 | 20/50/20 | 56 | 7.5 | 8.8 | 8.2 | 100 |
| Example 1 | | | | | | | |
| Comparative | 90 | 20/50/20 | 56 | 6.3 | 8.9 | 7.6 | 105 |
| Example 2 | | | | | | | |
| Comparative | 90 | 20/50/20 | 56 | 6.3 | 8.5 | 7.4 | 100 |
| Example 3 | | | | | | | |
| Comparative | 30 | 10/10/10 | 33 | 7.3 | 8.4 | 7.9 | 45 |
| Example 4 | | | | | | | |
| Comparative | 160 | 20/120/20 | 75 | 6.9 | 7.4 | 7.2 | 180 |
| Example 5 | | | | | | | |
| Comparative | 190 | 45/100/45 | 53 | 6.6 | 6.9 | 6.8 | 250 |
| Example 6 | | | | | | | |
| Comparative | 150 | 50/50/50 | 33 | 10.3 | 10.5 | 10.4 | 80 |
| Example 7 | | | | | | | |
| Comparative | 100 | 25/50/25 | 50 | 10.3 | 10.5 | 10.4 | 80 |
| Example 8 | | | | | | | |

| | | | | | | Interfacial adhesion | |
|---|---|---|---|---|---|---|---|
| | Fiber shape | | Scratch | Ease of | Long-term heat | Rubbing | Tensile |
| | retention | Flatness | resistance | handling | resistance | test | test |
| Example 1 | A | A | AA | AA | A | AA | A |
| Example 2 | B | A | AA | AA | A | AA | A |
| Example 3 | A | A | A | AA | A | A | A |
| Example 4 | A | A | AA | A | A | AA | A |
| Example 5 | A | A | B | AA | A | B | A |
| Example 6 | A | A | AA | B | A | AA | A |
| Example 7 | A | A | AA | AA | B | AA | A |
| Example 8 | A | A | B | AA | A | B | A |
| Example 9 | A | B | AA | AA | A | AA | A |
| Example 10 | B | A | AA | AA | A | AA | A |
| Example 11 | A | A | AA | B | A | AA | A |
| Example 12 | A | A | B | B | A | B | A |
| Example 13 | A | A | B | B | C | B | A |
| Example 14 | A | A | AA | B | C | AA | A |
| Comparative | A | A | C | A | B | C | C |
| Example 1 | | | | | | | |
| Comparative | C | C | C | A | B | C | C |
| Example 2 | | | | | | | |
| Comparative | A | B | C | A | B | C | C |
| Example 3 | | | | | | | |
| Comparative | A | A | C | A | C | C | C |
| Example 4 | | | | | | | |
| Comparative | A | A | C | C | B | C | C |
| Example 5 | | | | | | | |
| Comparative | A | A | C | C | C | C | C |
| Example 6 | | | | | | | |
| Comparative | A | B | C | B | C | C | C |
| Example 7 | | | | | | | |
| Comparative | A | B | C | A | B | C | C |
| Example 8 | | | | | | | |

### INDUSTRIAL APPLICABILITY

The laminate can be utilized as an electrical insulating paper for motors, capacitors, transformers, cables, high-voltage transmission transformers and the like.

1-9. (canceled)

10. A laminate comprising:
a biaxially oriented polyphenylene sulfide film layer (B layer); and
a fiber sheet (A layer) composed of an aromatic polymer bonded on at least one side of said biaxially oriented polyphenylene sulfide film layer without an adhesive,
wherein said laminate has an average tear strength of 1 to 6 N/mm in two perpendicular directions.

11. The laminate according to claim 10, wherein said fiber sheet is composed of a polyphenylene sulfide resin.

12. The laminate according to claim 10, wherein
said biaxially oriented polyphenylene sulfide film layer (B layer) has a three-layer laminated construction of X/Y/X or a two-layer laminated construction of X/Y,
a melting point of X layer, Tm(X), and that of Y layer, Tm(Y), have a relationship of Tm(X)<[Tm(Y)−10], and
a ratio of the thickness of said Y layer with respect to the total thickness of said film layer is 40% to 90%.

13. The laminate according to claim 10, wherein said average tear strength in said two perpendicular directions is 2 to 3.5 N/mm.

14. The laminate according to claim 10, having a total thickness of 40 to 150 μm.

15. The laminate according to claim 10, wherein, in a cross-section of said laminate, the ratio of said B layer with respect to the whole laminate is 50 to 90%.

16. The laminate according to claim 10, having a dielectric breakdown voltage of 60 to 350 kV/mm.

17. The laminate according to claim 10, used as an insulating paper for a motor.

18. The laminate according to claim 10, which does not have a reduction in stress that satisfies both of conditions (1) and (2) in a stress-strain curve obtained by tensile measurement in accordance with a method prescribed in JIS 02151:
(1) the stress is reduced by not less than 5 MPa while the elongation is increased by 2%; and
(2) the behavior of (1) is observed at a stage where the elongation is less than the elongation at break.
